(19) United States
(12) Patent Application Publication
(10) Pub. No.: US 2026/0170554 A1
(43) Pub. Date: Jun. 18, 2026

(54) Income Inference And Validation Using Layered Machine Learning Models

(71) Applicant: PointPredictive Inc., San Diego, CA (US)

(72) Inventors: Timothy J. Grace, Encinitas, CA (US); Frank J. McKenna, La Jolla, CA (US); Lev Golod, San Diego, CA (US)

(73) Assignee: PointPredictive Inc., San Diego, CA (US)

(21) Appl. No.: 18/981,228

(22) Filed: Dec. 13, 2024

(51) Int. Cl. G06Q 40/03; G06N 20/00; G06Q 30/0204

(52) U.S. Cl. CPC G06Q 40/03; G06N 20/00; G06Q 30/0205

(57) ABSTRACT

The present disclosure relates generally to an income inference and validation system. For example, the system can receive application data and a stated income. The system can further identify borrower attributes based on the application data and obtain table features. The table features can include subsets of the borrower attributes and corresponding feature values. The system can ingest the table features into a first machine learning (ML) model to generate a predicted income for the application. Additionally, the system can generate, by a second ML model in which the predicted income and the table features are ingested, an error estimate for the predicted income. The system can further ingest the predicted income, the error estimate, and the table features into a third ML model. The system can generate, with the third ML model an income score indicating a likelihood that the stated income is fraudulent.

### BACKGROUND

The present disclosure relates generally to improving electronic authentication and reducing risk of electronic transmissions between multiple sources using multiple communication networks.

Fraud can be prevalent in any context or industry. Customary verification techniques may rely on various forms of documentation to confirm an identity of or verify personal data (e.g., age, address, occupation) related to a person. However, when these verification requirements are implemented in an electronic environment, electronic authentication becomes an even more difficult problem to solve. For example, the documentation may be difficult to locate, or electronic versions of the documentation may be forged. Thus, improved techniques for verifying identity and personal data are required.

### BRIEF SUMMARY

One aspect of the present disclosure relates to a method for computing an income risk score, an income prediction, and an income range prediction. The method includes receiving an application associated with a borrower user, the application including application data and a stated income, identifying borrower attributes based on the application data, accessing a lookup table that relates subsets of the borrower attributes with a plurality of feature values, which plurality of feature values are computed using verified income data corresponding to the borrower attributes, obtaining a plurality of table features from the lookup table, each table feature of the plurality of table features includes a subset of the borrower attributes and a feature value, ingesting the plurality of table features into a first machine learning model, generating, with the first machine learning model and based on the plurality of table features, a predicted income for the application, generating, by a second machine learning model in which the predicted income and the plurality of table features are ingested, an income range estimate indicating a lower bound and upper bound that include a range that has a particular likelihood of containing a true income of the borrower user, ingesting the predicted income, the income range estimate, and the plurality of table features into a third machine learning model, and generating, with the third machine learning model and based on the predicted income, the income range estimate, and the plurality of table features, an income risk score indicating a likelihood that the stated income is overstated by at least a threshold amount relative to the true income of the borrower user.

### BRIEF DESCRIPTION OF THE DRAWINGS

FIG. 1 illustrates a distributed computing system for fraud detection according to an embodiment of the present disclosure.

FIG. 2 illustrates a fraud detection system according to an embodiment of the present disclosure.

FIG. 3 illustrates another example of the fraud detection system according to an embodiment of the present disclosure.

FIG. 4 illustrates an income scoring process according to an embodiment of the present disclosure.

FIG. 5 illustrates a lookup table for feature extraction according to an embodiment of the present disclosure.

FIG. 6 illustrates another lookup table for feature extraction according to an embodiment of the present disclosure.

FIG. 7 illustrates a sample output according to an embodiment of the present disclosure.

FIG. 8 illustrates another distributed computing system for fraud detection according to an embodiment of the present disclosure.

### DETAILED DESCRIPTION

In the following description, various embodiments will be described. It should be apparent to one skilled in the art that embodiments may be practiced without specific details, which may have been admitted or simplified in order to not obscure the embodiment described.

Embodiments of the present disclosure are directed to, among other things, an income inference and validation system. The income interference and validation system may receive application data and a stated income. The application data and stated income can be obtained from an application (e.g., a loan application) submitted by a borrower user. The system can identify borrower attributes for the borrower user based on the application data. For example, the system can identify an employer, occupation, age, and geographic indicator (e.g., an address) associated with the borrower user. The system can further access one or more lookup tables that relate subsets of the borrower attributes with feature values. Thus, based on identifying the borrower attributes for the borrower user, the system can obtain a plurality of table features from the one or more lookup tables. For example, each table feature can include a subset of borrower attributes (e.g., age and occupation) and a corresponding feature value (e.g., an average verified income value).

In some embodiments the system can further apply the table features to one or more machine learning (ML) models to characterize a risk of fraud with respect to the stated income. For example, a first ML model can be trained to generate a predicted income based on receiving the table features. The predicted income can be compared to the stated income to infer a risk of fraud. The predicted income and the table features can then be ingested into a second ML model, which can be trained to estimate a likely range for the predicted income, for example, by predicting the absolute error of the predicted income. Additionally, the income range, the predicted income, and the table features can be ingested into a third machine learning model, which can be trained to generate an income risk score. The income risk score can represent a likelihood that the stated income is overstated by at least a threshold amount (e.g., 15%) relative to the true income of the borrower user. The income risk score can be a value between 1 and 999 in which higher values can be associated with a greater likelihood that the stated income is fraudulent (e.g., overstated by at least 15%).

Embodiments of the application provide numerous improvements over conventional systems. For example, conventional systems may only target unusually high incomes without consideration of other attributes of the application or borrower that may affect the likelihood of income misrepresentation including borrower employer, occupation, age, or location. By predicting an income or scoring a stated income based on borrower employer, occupation, age, and/or location, more instances of overstated or fraudulent income statements in applications can be detected. Furthermore, by identifying a subset of applicants that exhibit low risk of income overstatement, this application can enable lenders to waive Proof of Income (POI) stipulations that may be costly to the lender and/or require significant additional effort on the part of the borrower user. By waiving such stipulations, the lender user may be more likely to win the borrower user's business after approving a loan. Additionally, the system can isolate the risk of income overstatement from other risk elements (e.g., a low credit score, previous loan defaulting, etc.) to enable targeted assessment of the applications and reporting of income risk to lender or deal users.

The system described herein further increases efficiency of application processing and reduces risk of fraudulent application approval in comparison with conventional systems. For example, conventional systems may only flag a seemingly high stated income, or may use non-income-related attributes such as credit scores to make decisions about income verification. In contrast, the system described herein can predict income for an application using a machine learning (ML) model. The system can further provide an estimated income range for an application using another ML model, enabling the lender to make intentionally conservative or aggressive assumptions about the likely income. The system can further provide a direct assessment of income misrepresentation risk using a third ML model, further informing the lender's income verification decisions. Additionally, the system can provide the score, predicted income, and other suitable information to a lender or dealer user associated with an application. In doing so, the lender or dealer user is provided an indication of risk with respect to income (e.g., the score) for the application with supporting evidence (e.g., the predicted income, normalized occupation, employer industry categories, etc.). Thus, approval, loan sizing, and income verification decisions regarding the application can be performed more efficiently and the risk of fraudulent application approval can be decreased.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

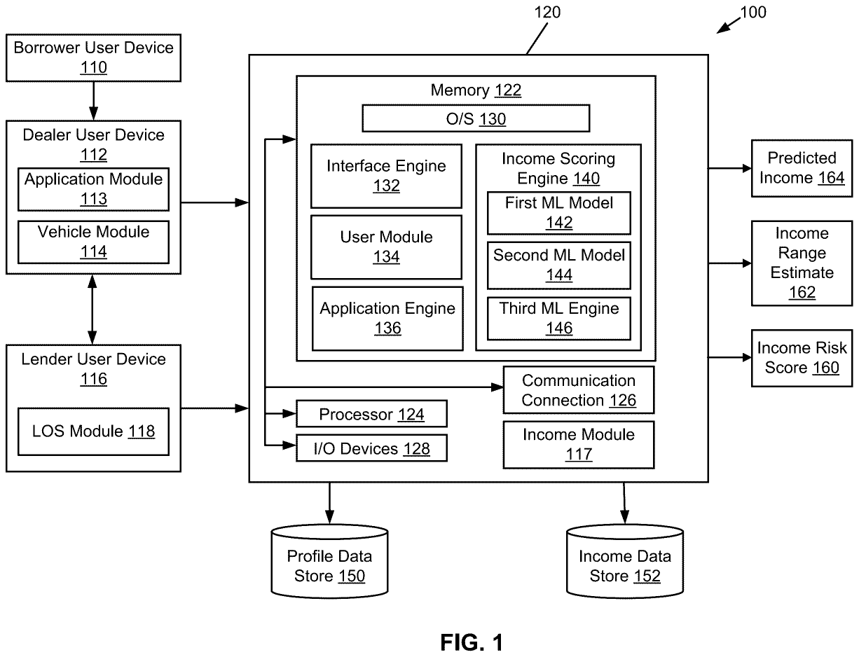

FIG. 1 illustrates a distributed computing system 100 for fraud detection according to an embodiment of the present disclosure. As illustrated, the distributed computing system 100 includes a borrower user device 110, a dealer user device 112, a lender user device 116, and a fraud detection computer system 120. In some examples, devices illustrated herein may comprise a mixture of physical and cloud computing components. Each of these devices may transmit electronic messages via a communication network. Names of these and other computing devices are provided for illustrative purposes and should not limit implementations of the disclosure.

The borrower user device 110, the dealer user device 112, and the lender user device 116 may display content received from one or more other computer systems, and may support various types of user interactions with the content. These devices may include mobile or non-mobile devices such as smartphones, tablet computers, personal digital assistants, and wearable computing devices. Such devices may run a variety of operating systems and may be enabled for Internet, e-mail, short message service (SMS), Bluetooth®, mobile radio-frequency identification (M-RFID), and/or other communication protocols. These devices may be general purpose personal computers or special-purpose computing devices including, by way of example, personal computers, laptop computers, workstation computers, projection devices, and interactive room display systems. Additionally, the borrower user device 110, the dealer user device 112, and the lender user device 116 may be any other electronic devices, such as a thin-client computers, Internet-enabled gaming systems, business or home appliances, and/or personal messaging devices, capable of communicating over network(s).

In different contexts, the borrower user device 110, the dealer user device 112, and the lender user device 116 may correspond to different types of specialized devices. In some embodiments, one or more of these devices may operate in the same physical location, such as a finance center or other location that manages or restricts access to items or services. In such cases, the devices may contain components that support direct communications with other nearby devices, such as wireless transceivers and wireless communication interfaces, Ethernet sockets or other Local Area Network (LAN) interfaces, etc. In other implementations, these devices need not be used at the same location but may be used in remote geographic locations in which each device may use security features and/or specialized hardware (e.g., hardware-accelerated SSL and HTTPS, WS-Security, firewalls, etc.) to communicate with the fraud detection computer system 120 and/or other remotely located user devices.

The borrower user device 110, the dealer user device 112, and the lender user device 116 may each include at least one memory and one or more processing units that may be implemented as hardware, computer executable instructions, firmware, or combinations thereof. The computer executable instruction or firmware implementations of the processor may include computer executable machine executable instructions written in any suitable programming language to perform the various functions described herein. These user devices may also include geolocation devices communicating with a global positioning system (GPS) device for providing or recording geographic location information associated with the user devices.

The memory may store program instructions that are loadable and executable on processors of the user devices, as well as data generated during execution of these programs. Depending on the configuration and type of user device, the memory may be volatile (e.g., random access memory (RAM), etc.) and/or non-volatile (e.g., read-only memory (ROM), flash memory, etc.). The user devices may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory may include multiple different types of memory, such as static random access memory (SRAM), dynamic random access memory (DRAM), or ROM.

The borrower user device 110, the dealer user device 112, the lender user device 116, and the fraud detection computer system 120 may communicate via one or more networks, including private or public networks. Some examples of networks may include cable networks, the Internet, wireless networks, cellular networks, and the like.

In some examples, the borrower user device 110 may provide application data to the dealer user device 112, the lender user device 116, the fraud detection computing system 120, or a combination thereof for a variety of purposes. The application data may be associated with one or more borrower users. A borrower user can be an individual or an entity (e.g., a business or organization) that may submit application data in a loan application or other suitable application type with the goal of receiving access to or funds for an item or service. The application data may include geographic, demographic, and/or employment data for the one or more borrower users. In some examples, the application data may contain a stated income value, location information (e.g., an address), demographic data, employment history, or other information that may be used to support the validity of the stated income.

Upon receiving the application data, the dealer user device 112, or the lender user device 116 may approve or restrict the access to or funds for the item or service. For example, a loan, lease, or purchase of the item or service may be approved, denied, or restricted. The verification of the stated income may be performed by the fraud detection computer system 120, while the approval or restriction of access to the item or service, which may depend at least in part on the verification of the stated income, may be determined by the lender user device 116.

Furthermore, the dealer user device 112 may correspond with a dealer user. The dealer user can be an individual or entity which sells or distributes the item or service (e.g., a vehicle). The dealer user device 112 can transmit and receive application data or other suitable data to and from the borrower user device 110, the lender user device 116, the fraud detection computing system 120, or a combination thereof. For example, a borrower user may submit application data, via the borrower user device 110, in a request for a loan to purchase a vehicle. The dealer user device 112 may receive the application data associated with the request and may transmit the application data and vehicle data (e.g., make, model, vehicle identification number (VIN), and price) to the lender user device 116.

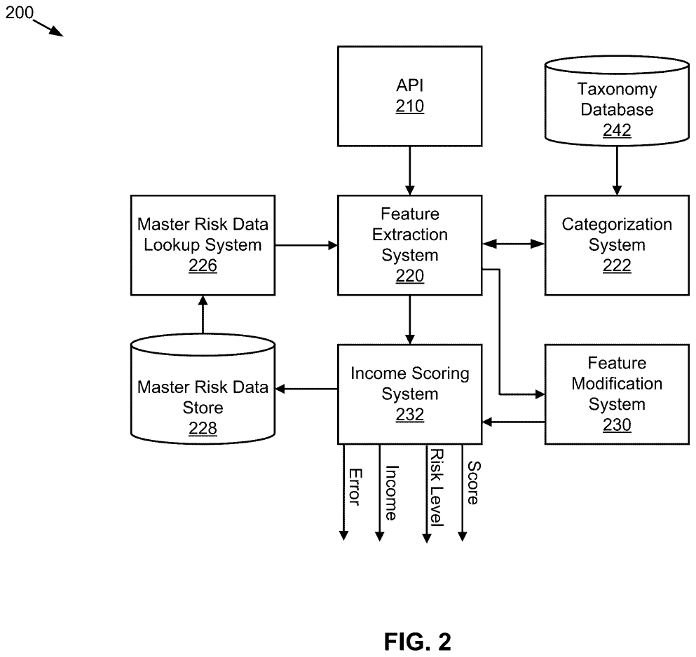

The dealer user device 112 may include an application module 113. The application module 113 may be configured to receive application data. The application data may be transmitted via a network from the borrower user device 110. Alternatively, in some examples, the application data may be provided directly at the dealer user device 112 via a user interface and without a network transmission. The application module 113 may provide a template to receive particular application data corresponding with characteristics (e.g., location, income, age, etc.) of a borrower user. The application module 113 may also be configured to transmit application data to the fraud detection computer system 120. The application data may be encoded in electronic message and transmitted via a network to an application programming interface (API) associated with the fraud detection computer system 120. Additional details regarding the transmission of this data are provided below with FIG. 2.

In some examples, the dealer user device 112 can further include a vehicle module 114. The vehicle module 114 may be configured to receive and provide vehicle data. For example, the dealer user may receive vehicle data, including make, model, vehicle identification number (VIN), price, and other relevant information to store in a data store of vehicles. The data store of vehicles may be managed by the dealer user to maintain data indicating an inventory of vehicles available to the dealer user. In some examples, the dealer user may offer the vehicles identified in the data store of vehicles with the vehicle module 114 to the borrower user in exchange for funding provided by the borrower user. The application data may be used, in part, to secure the funding in exchange for the vehicle.

The lender user device 116 may correspond with a lender user. The lender user can be an individual or entity (e.g., a financial institution), which may provide funds to a borrower user under an agreement for repayment. The lender user may perform an assessment of the borrower user's credibility with respect to repayment prior to providing the funds. To do so, the lender user device 116 may transmit or receive application data or other suitable information to and from the dealer user device 112, the borrower user device 110, the fraud detection computing system 120, or a combination thereof.

The fraud detection computing system 120 can comprise the income module 117. The income module 117 may provide statistical summaries of income data across different user segments, such as statistical summaries associated with location, employer, and occupation. The statistical summaries can further be associated with varying levels of aggregation at each user segment. For example, the income module 117 may provide statistical summaries for a ZIP code as well as a corresponding city and state. The income data from the income module 117 can be used by the fraud detection computer system 120, and specifically can be stored in a profile data store 150, an income data store 152, or a combination thereof. The income data can be used by the fraud detection computing system 120 in verifying stated incomes.

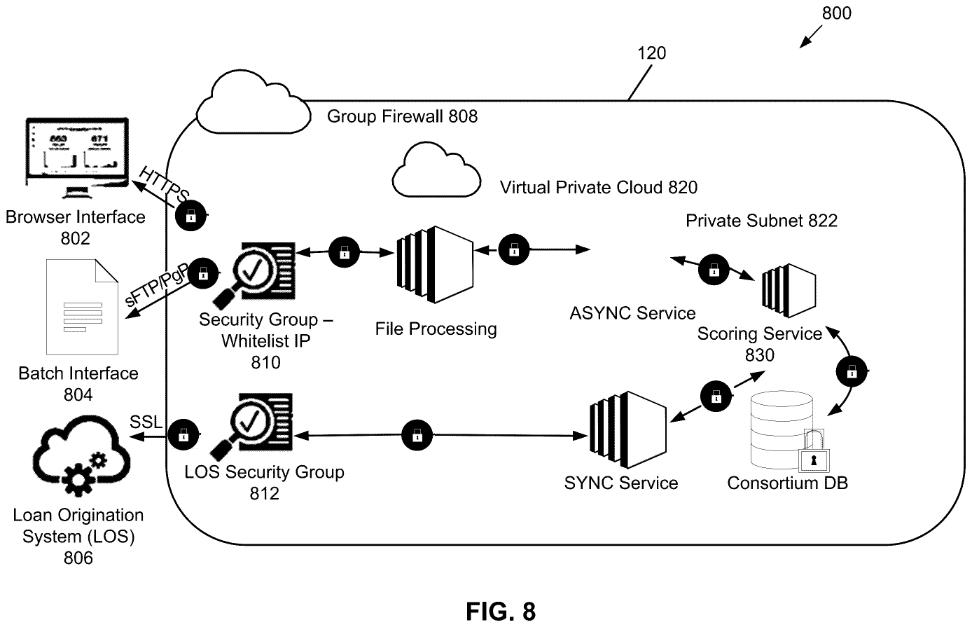

The lender user device 116 may comprise a LOS module 118. The loan origination system (LOS) module 118 may be configured to generate an application object with application data. Additional information associated with the loan origination module 118 is provided with FIG. 8.

Additionally, the borrower user device 110, the dealer user device 112, and the lender user device 116 may comprise one or more software applications for interacting with other computers or devices, including cloud-based software services, via a network (e.g., a LAN or the internet). The software applications may be capable of handling requests from users and information from various webpages. The software applications may further be capable of receiving application data or other information from and transmitting the application data or other information to various devices on the network.

The borrower user device 110, the dealer user device 112, the lender user device 116, or a combination thereof may further perform electronic communications with the fraud detection computer system 120. The fraud detection computer system 120 may correspond with any computing device or server on a distributed network, including processing units 124 that communicate with a number of peripheral subsystems via a bus subsystem. These peripheral subsystems may include memory 122, a communications connection 126, input/output devices 128, or a combination thereof.

The memory 122 of the fraud detection computer system 120 may include instructions that are loadable and executable on processor 124, as well as data generated during the execution of these programs. The memory 122 may be volatile (such as random access memory (RAM)) and/or non-volatile (such as read-only memory (ROM), flash memory, etc.). The fraud detection computer system 120 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, or the like for the fraud detection computer system 120. In some implementations, the memory 122 may include multiple different types of memory, such as solid-state drives (SSD), SRAM, DRAM, or ROM.

The memory 122 is an example of computer readable storage media. For example, computer storage media may include volatile or nonvolatile, removable or non-removable media, implemented in any methodology or technology for storage of information such as computer readable instructions, data structures, program modules, or other data. Additional types of memory computer storage media may include PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and can be accessed by the fraud detection computer system 120. Combinations of any of the above should also be included within the scope of computer-readable media.

The communications connection 126 may allow the fraud detection computer system 120 to communicate with a data store, one or more databases, servers, or other devices on the network. The fraud detection computer system 120 may also include input/output devices 128, such as a keyboard, a mouse, a voice input device, a display, speakers, a printer, and the like.

Reviewing the contents of memory 122 in more detail, the memory 122 may comprise an operating system 130, an interface engine 132, a user module 134, an application engine 136, an income scoring engine 140, or a combination thereof. The fraud detection computer system 120 may receive data from and store data in various data stores, such as the profile data store 150 and the income data store 152. The modules and engines described herein may be software modules, hardware modules, or a combination thereof. If the modules are software modules, the modules can be embodied in a non-transitory computer readable medium and processed by a processor with computer systems described herein.

The interface engine 132 may be configured to receive application data and/or transmit output (e.g., predictions, error estimates, scores, etc.) to user devices (e.g., the borrower user device 110, the dealer user device 112, or the lender user device 116). In some examples, the interface engine 132 may implement an application programming interface (API) to receive or transmit data.

The user module 134 may be configured to identify one or more users or user devices associated with the fraud detection computer system 120. The user module 134 may further associate each user or user device with a user identifier and a plurality of data. The user identifier and the plurality of data can be stored in the profiles data store 150.

Similar to the interface engine, the application engine 136 may be configured to receive application data from the borrower user device 110, the dealer user device 112, the lender user device 116, or a combination thereof via a network communication message, API transmission, or the like. The application engine 136 may filter or limit the application data received from the borrower user device 110, the dealer user device 112, or the lender user device 116. The application engine 136 may further store historical application data, including income scores determined by the fraud detection computing system 120 for previous applications.

For example, the fraud detection computing system 120 may determine an estimated income, income range, and income risk score for an application and transmit the estimated income, income range, and income risk score and supporting data (e.g., normalized occupation, employer industry categories, etc.) to the lender user device 116. As a result, the application may be approved by the lender user device 116, and the lender user device 116 may provide funds to the borrower user device 110. The indication of approval, the income score, and the application data for the application may then be stored, by the application engine 136, in the profile data store 150 with a user identifier for the borrower user and/or borrower user device 110. Additionally, or alternatively, the income score, application data, etc. can be stored, by the application engine 135, in the income data store 152.

The income scoring engine 140 can be configured to generate outputs of the fraud detection computing system 120. The outputs may be transmitted via the interface engine 132 to the borrower user device 110, the dealer user device 112, the lender user device 116, or a combination thereof. In some examples, the outputs may be provided as an electronic notification to a user device.

To generate the outputs, the income scoring engine 140 can include a first ML model 142, a second ML model 144, and a third ML model 146. The first ML model 142 may be trained and configured to determine a predicted income 164 based on application data. The second ML model 144 may be trained and configured to determine an income range estimate 162 for the predicted income of the first ML engine. The third ML model 146 may be trained and configured to predict an income risk score 160 characterizing a likelihood that a stated income is greater than a true income by at least a threshold amount (e.g., 15%). The first ML model 142, the second ML model 144, and the third ML model 146 may be trained using historical application data, verified income data, or a combination thereof. Additional description related to model training and outputs are provided below with FIGS. 2-4.

FIG. 2 illustrates a fraud detection system 200 according to an embodiment of the present disclosure. The fraud detection system 200 can be a distributed computing system and may correspond to the fraud detection computer system 120 of FIG. 1. The fraud detection system 200 may be implemented to detect fraud with respect to a stated income in an application, such as a loan application.

The fraud detection system 200 may include application programming interface (API) 210. The API 210 may be used by devices to communicate with the fraud detection system 200. For example, API 210 may correspond to a website that allows devices to submit a loan application. In other examples, the API 210 may correspond to a receiver that is configured to receive a batch of one or more loan applications. Additionally, in some examples, the API 210 may allow a remote service (e.g., a web service) that is executing on the devices to communicate with the fraud detection system 200. The web service may have a direct connection with the fraud detection system 200 such that the devices may submit a loan application without having to navigate to a web page or send loan applications using the receiver.

The fraud detection system 200 may further include a feature extraction system 220 for identifying features from applications. To identify the features, the feature extraction system 220 may identify borrower attributes from an application and calculate various feature values for each borrower attribute. For example, information such as borrower information, dealer information, lender information, and application information may be received using API 210. Then borrower attributes or other suitable attributes can be obtained from the information. The borrower attributes can include a geographic indicator (e.g., based on an employer address or an applicant address included in the application), an age (e.g., based on a date of birth included in the application), an employer, and an occupation.

Additionally, or alternatively, the feature extraction system 220 may identify taxonomy values for each of the borrower attributes, which may differ in scope. For example, taxonomy values for age may include a year (e.g., 35) and a decade (e.g., 30-40) and the taxonomy values for geographic indicator may include a zip code, city, and state. To determine the taxonomy values, the feature extraction system 220 may transmit the borrower attributes to a categorization system 222. The categorization system 222 may have access to a taxonomy database 242, which may include a lookup table that relates various ages, geographic indicators, employers, and occupations to various taxonomy values.

In some embodiments, the identified taxonomy values can correspond to a taxonomy that is less granular than the associated borrower attribute(s). For example, the borrower may input a zip code, which can be used to find a taxonomy value corresponding to the borrower's state. In some embodiments, and specifically with respect to geographic attributes and taxonomies, abstracting to a less granular taxonomy can protect vulnerable people and/or vulnerable classes by abstracting from a smaller geography to a larger geography, which larger geography will contain a more heterogenous sample of people.

In some examples, the lookup table may not include a specific employer or occupation. Thus, to generate taxonomy values for employers and occupations that are not included in the lookup table, a generative artificial intelligence (AI) model (e.g., Chatbot GPT) may be used. For example, the generative AI model can be configured to output a number (e.g., 2, 5, etc.) of employer categories, occupation categories, or a combination thereof with varying scope when provided an employer and occupation. The employer and occupation categories generated by the generative AI model can be stored in taxonomy database 242 by updating the lookup table to relate the employer and the occupation to the respective categories.

Once the borrower attributes and the taxonomy values for the borrower attributes have been identified, the feature extraction system 220 may access verified income data, historical application data, or other suitable data related to the borrower attributes, the taxonomy values, or a combination thereof. The historical application data can be information which was received through API 210 or previous outputs of an income scoring system 232. For example, the historical application data may include stated incomes, demographic data, geographic data, employment data, or other suitable data included in previous applications. The historical application data can also include predicted incomes, income scores, or the like output by the income scoring system 232 in association with the previous applications. The verified income data can include income values for various employers, occupations, or individuals which have been verified using, for example, published income data, financial statements, or the like.

The historical application data and verified income data can be received by the feature extraction system from the master risk data lookup system 226. The master risk data lookup system 226 may obtain the historical application data and verified incomes from one or more data stores (e.g., master risk data store 228, profile data store 150, and/or income data store 152). The master risk data lookup system 226 may organize or transmit the data and information by user groups associated with borrower attributes. For example, data related to a particular age group, location, employer, or occupation can be packaged and transmitted to the feature extraction system 220.

Thus, the feature extraction system 220 can retrieve data related to the borrower attributes, etc. from the master risk data lookup system 226 and perform various calculations to determine feature values. In some examples, the feature values may be computed by performing a mathematical operation on a piece of information associated with the loan application. For example, the natural logarithm of a stated income from the loan application can be computed. In other examples, verified income data for users with the same or similar borrower attributes (e.g., similar age, location, occupation, employer, or a combination thereof) can be used to compute feature values. For example, a number of verified incomes associated with a particular borrower attribute or combination of borrower attributes can be computed. As another example, an average of the natural logarithm of verified incomes for the borrower attribute or combination of borrower attributes can be computed. Additionally, the verified income data can be compared with corresponding stated income data to compute a number or percent of the stated incomes that exceed corresponding verified incomes by at least 15%.

In some examples, the feature extraction system 220 may transmit each feature value to a feature modification system 330. The feature modification system 230 may modify the feature values in order to obtain better results from the income scoring system 232. For example, feature modification system 330 may normalize, transform, and/or scale the features values, and then output the modified feature values to the income scoring system 232.

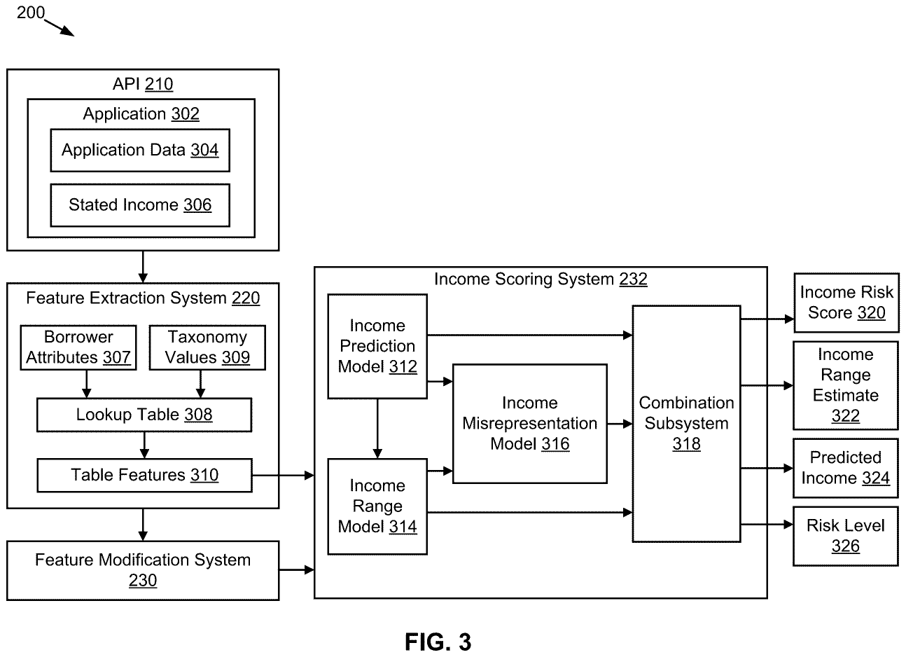

At the income scoring system 232, features, including the borrower attributes, taxonomy values, and corresponding feature values, can be received and used to generate various outputs. For example, the outputs can include a score (e.g., an income risk score indicating a likelihood that a stated income in an application is fraudulent), an income (e.g., a predicted income for an application), a range estimate associated with the income, and/or a risk level based on the score. The outputs may be used by a lender to determine a likelihood that the borrower has lied about their income, which can indicate that the application is fraudulent. To generate the outputs, the income scoring system 232 may use one or more ML models to compute the outputs. Details of the ML models are discussed below in FIGS. 3-5.

FIG. 3 illustrates another example of the fraud detection system 200 according to an embodiment of the present disclosure. In some examples, the fraud detection system 200 can include an API 210. The API 210 can enable devices within a distributed computing environment, which includes the fraud detection system 200, to communicate. Thus, the API 210 may receive, for example, an application 302 for a loan from a user device, such as borrower user device 110, dealer user device 112, or lender user device 116 depicted in FIG. 1. In an example, the application 302 can be a loan application submitted by a borrower user via a borrower user device. The loan application can be included in a request for funds for an item (e.g., a vehicle) provided by a dealer user associated with the dealer user device 112. A lender user associated with the lender user device 116 may provide or deny the funds based on the application 302 and information provided by the fraud detection system 200, as described in further detail below. The application 302 can include at least application data 304 and a stated income 306 related to the borrower user. The API 210 may further be configured to generate or receive additional application data. For example, the additional application data may include dealer or lender information.

The fraud detection system 200 can further include a feature extraction system 220, which can receive the application data 304 and stated income 306 from the API 210 and identify borrower attributes 307. The borrower attributes 307 can be based on the application data 304. For example, the application data 304 may include information usable to identify one or more characteristics of the borrower user, such as name, address, income, employment information, credit score, or the like. As a result, the borrower attributes 307 can include an employer, an occupation, an age, and a geographic indicator (e.g., an address or zip code) for the borrower.

The feature extraction system 220 can further identify, for each of the borrower attributes 307, one or more taxonomy values 309. For example, the taxonomy values 309 for the occupation and employer can be an industry, a field within the industry, and a role or position within the field. For example, the occupation and the employer for the borrower user may be an oncology nurse at a particular hospital. Thus, the taxonomy values 309 for the employer may include healthcare facilities, oncology, and the particular hospital. For occupation, the taxonomy values 309 may include nursing, nursing position type (e.g., staff nurse, charge nurse, etc.), and oncology nurse.

Additionally, the taxonomy values 309 can vary in scope. Taxonomy values 309 for a borrower attribute that vary in scope may be associated with different taxonomy levels. For example, the taxonomy values 309 for the geographic indicator can be a corresponding city and state and the taxonomy values 309 for the age can be a year and decade. Because city and year are narrower in scope than state and decade, the city and year can be associated with a lower taxonomy level than the state and decade.

The feature extraction system 220 can further access a lookup table 308 that relates subsets of the borrower attributes 307, the taxonomy values 309, or a combination thereof with feature values. For example, the lookup table 308 can relate the various borrower attributes 307 or combinations of the borrower attributes 307 (e.g., age and occupation, geographic indicator and occupation, occupation and employer, etc.) to various feature values. The lookup table 308 may further relate taxonomy values 309 of the borrower attributes 307 (e.g., decade of age and field of occupation, zip code and industry of employer, city and role in occupation, etc.) to the various feature values.

The feature values may be computed using verified income data, historical application data, historical predicted income data, historical income scoring data, etc., associated with borrowers with attributes that match the borrower attributes or taxonomy values being analyzed. For example, the data used to compute a set of feature values may be verified income data and historical application data for borrowers fitting a particular decade of age and field of occupation. The set of feature values for a borrower attribute, a taxonomy value, or of a combination of borrower attributes or taxonomy values, may include a number of observed verified income values related to the borrower attribute, taxonomy value, or combination of interest, an average of the verified income values, and a standard deviation of the verified income comes. The average and the standard deviation of the natural logarithm of the values may also be included in the set of feature values. Additionally, the set of feature values may include a number or percent of observed stated income values (e.g., from the historical application data) that are greater than corresponding verified income values by a threshold amount (e.g., 15%).

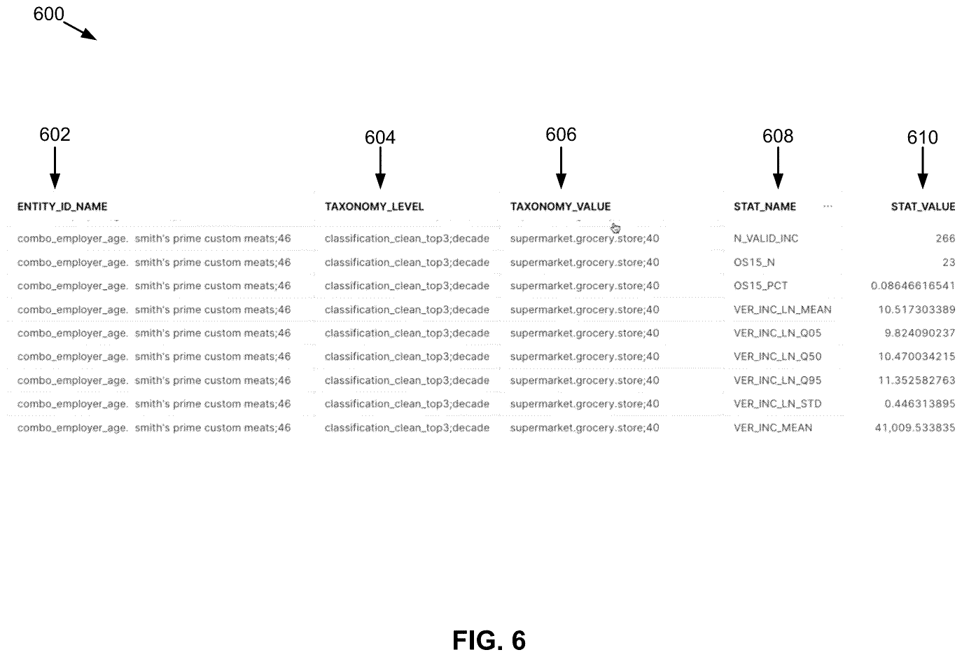

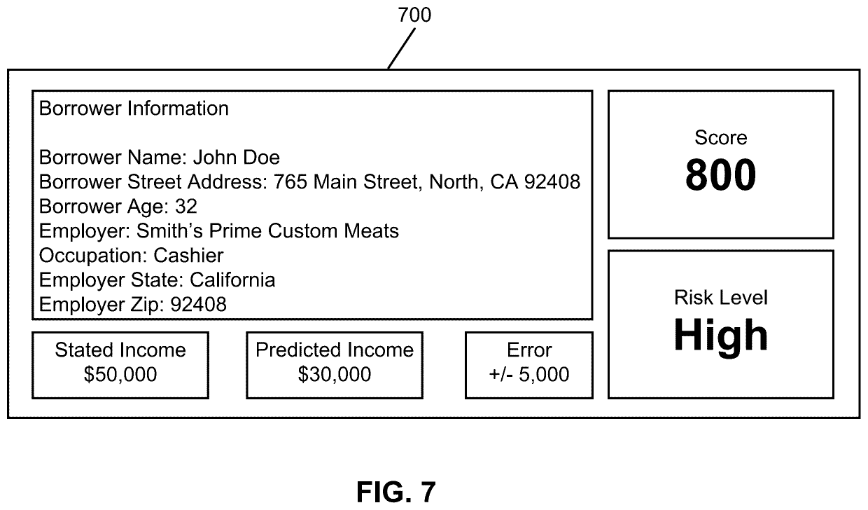

Thus, the feature extraction system 220 can obtain table features 310 from the lookup table 308. Each table feature 310 can include one or more borrower attributes, one or more taxonomy values for the borrower attributes, and a feature value. Some of the table features 310 may have the same borrower attributes and taxonomy value with a different feature value. An example of a group of table features with the same borrower attribute and taxonomy value combination and different feature values is depicted in FIG. 7. Additionally, example combinations of borrower attributes and taxonomy values are shown in lookup table 600 depicted in FIG. 6. Furthermore, a taxonomy level for the taxonomy values can be included in a table feature. In some examples, a high taxonomy level (e.g., a taxonomy value with a broader scope) may be used to increase the amount of data used to compute a feature value.

At the income scoring system 232, the table features 310 can be ingested into an income prediction model 312 to generate a predicted income 324 for the application 302. The income prediction model 312 can correspond to the first machine learning (ML) model 142 depicted in FIG. 1. Various ML models and embodiments of the disclosure can be applied. For example, the income prediction model 312 may comprise a supervised learning algorithm (e.g., a decision tree or support vector machine (SVM)) that accepts the table features 310 associated with the application 302 and provides the predicted income 324.

In some examples, the income prediction model 312 may use an ensemble modeling method, which combines income predictions from a plurality of ML models or other methods to compose an integrated prediction. For example, the income prediction model 312 may comprise a gradient boosting algorithm (e.g., XGBoost). Implementation of the gradient boosting algorithm may involve execution of an ensemble of models (e.g., linear regression models, or other XGBoost models built on different subsets of the historical data) to output an accurate prediction of income. The ensemble of models can be executed sequentially with each model aiming to correct error associated with the preceding models.

In another example, the income prediction model 312 can use an XGBoost regression model to measure the relationship between a dependent variable (e.g., income) and one or more independent variables (e.g., the table features). Alternatively, the income prediction model 312 can use linear regression, in which the income prediction model 312 can be trained to predict income based on a relationship between a dependent variable (e.g., income) and one or more independent variables (e.g., the table features). The relationship between the dependent variable and the one or more independent variables can be established by estimating probabilities using a linear function.

Additionally, the income prediction model 312 may comprise a neural network, in which multiple layers of processing elements, which ascertain non-linear relationships and interactions between independent variables (e.g., the table features 310) and the dependent variable (e.g., income), are used to output a predicted income. The income prediction model 312 may further comprise a Deep Learning Neural Network, consisting of more than one layer of processing elements between the input layer (i.e., the layer at which the table features 310 are received) and the output layer (i.e., the layer which outputs the predicted income 324). The income prediction model 312 may further include a Convolutional Neural Network, in which successive layers of processing elements each contain particular hierarchical patterns of connections with the previous layer.

The income prediction model 312 may further comprise an unsupervised learning method, such as k-nearest neighbors, to classify inputs based on observed similarities among the multivariate distribution densities of independent variables in a manner that may correlate with particular income values or income value ranges.

Prior to receiving the table features 310 associated with the application data 304, the income prediction model 312 may be trained using a training data set of verified income data. For example, the training data set may comprise a plurality of verified income data for a plurality of employers and occupations in a variety of locations. Additionally, or alternatively, the training data set may comprise a plurality of verified income data for a plurality of individuals along with information such as employer, occupation, age, employer location, etc. for each individual. The income prediction model 312 may be trained using the verified income data to predict income based on borrower attributes and corresponding features values. The prediction by the income prediction model 312 may depend exclusively on the table features 310 identified based on the application data 304, and not on the stated income 306.

The predicted income 324 output by the income prediction model 312 in response to receiving the table features 310 can be the logarithm of an income value. An alternative output of the income prediction model 312 can be a difference between the stated income 306 and the predicted income 324 in the case that the stated income is used as an input feature to the model.

After generating the predicted income 324, the fraud detection system 200 can ingest the table features 310 and the predicted income 324 into an income range model 314 to generate an income range estimate 322. The income range estimate 322 can indicate an uncertainty for the predicted income 324 from the income prediction model 312. The income range model 314 can correspond to the second ML model 144 depicted in FIG. 1. The income range model 314 may comprise, for example, a supervised learning algorithm (e.g., a decision tree or support vector machine (SVM)) that accepts the predicted income 324 and table features 310 to provide the income range estimate 322.

In some examples, the income range model 314 may use an ensemble modeling method, which combines income and income range predictions from a plurality of ML methods or other methods to compose an integrated prediction. For example, the income range model 314 may comprise a gradient boosting algorithm (e.g., XGBoost). Implementation of the gradient boosting algorithm may involve execution of an ensemble of models (e.g., linear regression models, or other XGBoost models built on different subsets of the historical data) to output an accurate estimate of range for the predicted income 324. The ensemble of models can be executed sequentially with each model aiming to correct the error estimate provided by the preceding models.

In some embodiments, the income range model 314 can use linear regression, in which the income range model 314 can be trained to estimate absolute error for the predicted income 324 based on a relationship between a dependent variable (e.g., absolute error) and one or more independent variables (e.g., the table features 310 and the predicted income 324). The relationship between the dependent variable and the one or more independent variables can be established by estimating probabilities using a linear function.

Additionally, the income range model 314 may comprise a neural network model, in which multiple layers of processing elements, which ascertain non-linear relationships and interactions between the independent variables and the dependent variable, are used to output an estimate of the absolute error of the predicted income 324. The income range model 314 may further comprise a Deep Learning Neural Network, consisting of more than one layer of processing elements between the input layer (i.e., the layer at which the table features 310 are received) and the output layer (i.e., the layer which outputs the income range estimate 322). The income range prediction model 314 may further include a Convolutional Neural Network, in which successive layers of processing elements contain particular hierarchical patterns of connections with the previous layer.

The income range model 314 may further comprise an unsupervised learning method, such as k-nearest neighbors, to classify inputs based on observed similarities among the multivariate distribution densities of independent variables in a manner that may correlate with the amount of deviation (e.g., absolute error) the predicted income 324 may have from a true income value.

Prior to receiving the table features 310 and the predicted income 324, the income range model 314 may be trained using a training data set of verified income data. For example, the training data set may comprise a plurality of verified income data for a plurality employers and occupations in a variety of locations and corresponding predicted income values from the income prediction model 312. By using differences between the verified income data and outputs of the income prediction model 312, the income range model 314 can be trained to estimate absolute error for the predicted income 324.

The output (i.e., the income range estimate 322) of the income range model 314 can be an absolute error. The error estimate 322 can be interpreted as an estimate of how many log units away from the predicted log income 334 a true income of the borrower is expected to be. Thus, an income prediction range can be identified based on the error estimate 322. A second output of the income range model 314 can be a z-score for the stated income. The z-score can be calculated with equation (1) below.

$$Z - {score}_{stated income} = \frac{ln ( stated income ) - ( {predicted}_{¿} )}{{predicted}_{¿}} \qquad ( Equation 1 )$$

Once, the income range estimate 322 has been obtained, the fraud detection system 200 can ingest the predicted income 324, the income range estimate 322, and the table features 310 into an income misrepresentation model 316. In some examples, the difference between the predicted income 324 and the stated income 306, the z-score for the stated income, or a combination thereof can also be ingested into the income misrepresentation model 316. The income misrepresentation model 316 can correspond to the third ML model 146 depicted in FIG. 1.

Additionally, in some examples, prior to ingesting the table features 310, the predicted income 324, the income range estimate 322, etc. into the income misrepresentation model 316, a smoothing update such as a Bayesian adjustment, also referred to herein as a Bayesian update, can be performed to reduce error associated with small sample sizes. For example, for each of the table features 310, the income scoring system 323 can retrieve a feature value, a prior value, and a number of data records used to calculate the feature value. The prior value can be a population level average for the feature. For example, the feature value can be an average income for a particular occupation and age range (e.g., nurses between 30 and 40 years old). The prior value can then be, for example, an average income for nurses of all ages. The Bayesian update can involve updating the feature value based on a comparison of the feature value and the prior value and based on the number of data records. For example, if there are few data records the feature value may be updated to closely resemble the prior value. In contrast, if there are many data records, the feature value may not be significantly updated.

The income misrepresentation model 316 can generate an income risk score 320, also referred to herein as an income score 320, based on the predicted income 324, the income range estimate 322, the table features 310, the difference between the predicted income 324 and the stated income 306, the z-score, other borrower attributes, or a combination thereof. The income score 320 can characterize a risk that the stated income 306 is greater than a true income of the borrower by at least a threshold amount (e.g., 15%). The income misrepresentation model 316 can be a machine learning (ML) model configured to generate the income score 320. For example, the income misrepresentation model 316 may comprise a supervised learning algorithm including a decision tree that accepts the above input features (e.g., the predicted income 324, the income range estimate 322, etc.) associated with the application to provide the income score 320.

In an example, the income misrepresentation model 316 can include an ensemble modeling method, which combines scores from a plurality of ML models or other methods to comprise an integrated income score. For example, the error model 314 may comprise a gradient boosting algorithm (e.g., XGBoost classifier), which can use an ensemble of models (e.g., logistic regression models or XGBoost models built on different subsets of the historical data) to output the income risk score 320.

In another example, the income misrepresentation model 316 may comprise a Naive Bayes classifier that associates independent assumptions between the input features.

Additionally, in some examples, the income misrepresentation model 316 may use logistic regression to measure the relationship between a dependent variable (e.g., the likelihood of that the stated income is fraudulent) and one or more independent variables (e.g., predicted income 324, the error estimate 322, and the table feature 310) by estimating probabilities using a logistic function. Alternatively, the income misrepresentation model 316 can use linear regression to measure the relationship between the dependent variable (e.g., the likelihood of that the stated income is fraudulent) and one or more independent variables (e.g., predicted income 324, the income range estimate 322, and the table feature 310) by estimating probabilities using a linear function.

The income misrepresentation model 316 may, in another example, comprise a neural network classifier that measures the relationship between the dependent variable and the independent variables by estimating probabilities using multiple layers of processing elements that ascertain non-linear relationships and interactions between the independent variables and the dependent variable. The income misrepresentation model 316 may further comprise a Deep Learning Neural Network, consisting of more than one layer of processing elements between the input layer (i.e., the layer at which the predicted income 324, the income range estimate 322, and the table feature 310 are received) and the output later (i.e., the layer at which the income score is produced). The income misrepresentation model 316 may further be a Convolutional Neural Network, in which successive layers of processing elements each contain particular hierarchical patterns of connections with the previous layer.

The income misrepresentation model 316 may further comprise an unsupervised learning method, such as k-nearest neighbors, to classify inputs based on observed similarities among the multivariate distribution densities of independent variables in a manner that may correlate with fraudulent activity (e.g., inaccurate income reporting in applications).

The income misrepresentation model 316 may further comprise an outlier detection method, which identifies significant deviations from the multivariate density distributions of a plurality of independent variables, even if such deviations have not previously been correlated with fraudulent incomes in historical application data.

Prior to receiving the predicted income 324, the income range estimate 322, the table feature 310, etc., the income misrepresentation model 316 may be trained using a training data set of historical application data. For example, the training data set may comprise a plurality of application data and determinations of whether the stated income associated with the application data was fraudulent (e.g., overstated by at least 15%). The income misrepresentation model 316 may be trained to determine weights assigned to each of the input features based on historical data (e.g., previous income scores, income fraud rates for particular taxonomy values, etc.). Additionally, input features from the historical data that are common amongst a subset of applications may be identified as indicators of potential income fraud. For example, particular employers or occupations may be associated with high rates of income fraud. Additionally, the ML model may determine thresholds for the difference between and predicted income and stated income, accounting for the error, which can be associated particular income scores or income score ranges based on the historical data.

The income risk score 320 output by the income misrepresentation model 316 can be a value between 1-999, where higher values are associated with a greater likelihood than the stated income is fraudulent. In particular, the value can indicate the likelihood that the stated income 306 is overstated by at least 15% relative to a true income of the borrower.

Subsequent to generating the income risk score 320, the income scoring system 232 may perform one or more post-processing steps on the income score 320, the predicted income 324, the income range estimate 322, or a combination thereof. For example, a post processing step may involve adjusting the predicted income 324 based on the income risk score 320 and based on a difference between the predicted income 324 and the stated income 306, particularly in cases in which the stated income is not used as an input to the income prediction. For example, if the income score 320 is low (e.g., below 300), thereby indicating a low likelihood that the stated income 306 is greater than the true income by at least 15%, the predicted income 324 may be adjusted to be closer to the stated income 306. For example, the average of the predicted income 324 and the stated income 306 may be calculated and the average may be output as the predicted income 324.

In another example, a post-processing step may involve adjusting the income range estimate 322 based on the income risk score 320. For example, if the income risk score is low (e.g., below 300), the stated income 306 may be within or below the predicted income range. Additionally, if the income score is moderate (e.g., between 300 and 600), the stated income 306 may be within the predicted income range. Finally, if the income score is high (e.g., greater than 600), the stated income 306 may be within or above the predicted income range. Thus, if the stated income 306 does not fall as expected below, within, or above the predicted income range based on the income risk score 320, the predicted income range can be shifted or the error estimate 322 can be increased or decreased to broaden or narrow the predicted income range.

Subsequent to the execution of the income prediction model 312, the income range model 314, and the income misrepresentation model 316, and any required post processing of outputs, the income scoring system 232 may, in some examples, generate an output. For example, the income scoring system 232 may further include combination subsystem 318 for combining outputs from the various models to generate the output. The output can include the income risk score 320, the income range estimate 322, the predicted income 324, a risk level 326, or other suitable relevant information. The risk level 326 can correspond to the income risk score 320. For example, the risk level 326 can be low, moderate, or high based on the income risk score 320. The output may be received at the dealer user device 112 or the lender user device 116. For example, the income risk score 320 may be sent to the lender user device 116 to enable the lender user to determine whether or not to grant the loan associated with the application 302.

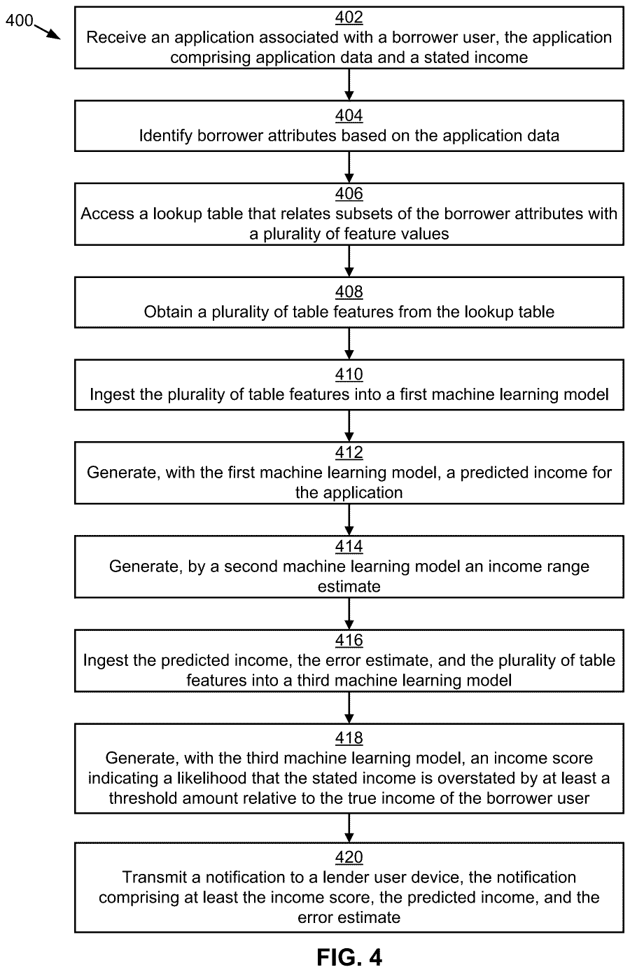

FIG. 4 illustrates an income scoring process 400 according to an embodiment of the present disclosure. In some examples, the fraud detection computer system 120 of FIG. 1 may perform the process 400 by implementing one or more modules (e.g., the interface engine 132, the user module 134, the application engine 136, the profiling module 138, or the income scoring engine 140). Additionally, or alternatively, the fraud detection system 200 of FIGS. 2-3 may perform the process 400 by implementing one or more systems (e.g., master risk data lookup system 226, feature extraction system 220, income scoring system 232, categorization system 222, etc.). The process 400 can include more operations, fewer operations, different operations, or a different order of the operations than is shown in FIG. 4. The operations of FIG. 4 are described below with reference to the components of FIGS. 1-3 above.

At block 402, the process 400 can involve the fraud detection system 200 receiving an application 302 associated with a borrower user. The application 302 may include application data 304 and a stated income 306. In an example, the application 302 (e.g., a loan application) may be completed by or on behalf of the borrower user for an item (e.g., a vehicle) offered by a dealer user. In the example, the application data 304 can include an employer (e.g., a particular supermarket), an occupation (e.g., cashier), an age (e.g., 25), a location (e.g., an address), or other suitable information related to the borrower user. Additionally, in the example, the stated income can be $35,000.

The application 302 can be transmitted via a borrower user device 110 to a dealer user device 112. The dealer user device 112 may then submit the application data 304 and stated income 306 associated with the application 302 to a lender user device 116 to request funding in exchange for the item on behalf of the borrower user. As a result, the lender user device 116 may transmit the application data 304 and stated income 306 to a fraud detection system 200. The lender user device 116 may further transmit a request for an income fraud prediction from the fraud detection system 200.

At block 404, the process 400 can involve the fraud detection system 200 identifying borrower attributes 307 based on the application data 304. The borrower attributes 307 can include an employer, an occupation, an age, and a geographic indicator for the borrower user. Thus, in the example, the fraud detection system 200 may identify, from the application data 304, that the employer is the particular supermarket, the occupation is cashier, the age is 25, and the geographic indicator is the state of California. In some examples, the process 400 may further involve the fraud detection system 200 identifying taxonomy values 309 for the borrower attributes.

At block 406, the process 400 can involve the fraud detection system 200 accessing a lookup table 308 that relates subsets of the borrower attributes 307 with a plurality of feature values. In the example, a first subset of the borrower attributes 307 can include employer and age, a second subset can include employer and geographic indicator, a third subset can include employer and occupation, a fourth subset can include age and geographic indicator, a fifth subset can include age and occupation, and a sixth subset can include geographic indicator and occupation. In other examples, there can be a different number of subsets. Additionally, in other examples, each subset can include a different number of attributes (e.g., 1 or 3).

For each subset, feature values can be calculated using verified income data, historical application data, or the like. The data used for each subset may be associated with taxonomy values 309 of each borrower attribute. For example, for the first subset, verified income data and historical application data for borrowers between the ages of 20 and 30 and working at supermarket or grocery store can be used to calculate the feature values. The feature values can include a number of verified incomes, the mean of a natural logarithm (ln) of the verified incomes, the 5^{th} percentile of a distribution of the ln of the verified incomes, the 50^{th} percentile of the distribution of the ln of verified incomes, the 95^{th} percentile of the distribution of the ln of the verified incomes, the standard deviation of the ln of the verified incomes, a mean of the verified incomes, etc. Additionally, the verified incomes can be compared with stated incomes from historical application data. Thus, a number and/or percentage of the stated incomes which are at least 15% greater than the verified incomes can also be feature values.

At block 408, the process 400 can involve the fraud detection system 200 obtaining a plurality of table features 310 from the lookup table 308. Each of the plurality of table features 310 can include a subset of the borrower attributes 307 and a feature value. The table features 310 may further include taxonomy values 309, taxonomy level, or a combination thereof associated with the data used to compute the feature values. For example, both supermarkets and grocery store related data can be associated with a second taxonomy level. Thus, supermarkets, grocery stores, and an indication of taxonomy level 2 may be included in associated table features.

At block 410, the process 400 can involve the fraud detection system 200 ingesting the plurality of table features 310 into a first machine learning model. The first machine learning model can be an income prediction model 312 trained and configured to output a predicted income 324 value in response to receiving the table features 310.

At block 412, the process 400 can involve the fraud detection system 200 generating, with the first machine learning model, a predicted income 324 for the application 302. The first machine learning model can be an XGBoost regressor, which implements a series of gradient boosted decision trees to predict an income value based on the table features 310. In the example, the first machine learning model can generate a predicted income 324 of $30,000.

At block 414, the process 400 can involve the fraud detection system 200 generating, by a second machine learning model in which the predicted income 324 and the plurality of table features 310 are ingested, an income range estimate 322. The second machine learning model can be the income error model 314 trained and configured to estimate and/or generate an income range estimate 322 for the output of the first machine learning model. In some embodiments, this income range estimate can comprise an absolute error of the income prediction. In some embodiments, this income range estimate can be generated based on a quantile regression. In some embodiments, the income range estimate has a 50% likelihood of containing an actual income of the borrower.

In some embodiments, the second machine learning model may also be an XGBoost regressor which implements a series of gradient boosted decisions trees to predict absolute error for the output of the first machine learning model. The absolute error estimate 322 can provide a predicted absolute value of the difference between the predicted income 324 and a true income of the borrower user. In the example, the error estimate 322 can be +/−$3,000. In some examples, the predicted income 324 may be output as a logarithmic value and the absolute error estimate 322 can be provided in logarithmic units.

At block 416, the process 400 can involve the fraud detection system 200 ingesting the predicted income 324, the absolute error estimate 322, and the plurality of table features 310 into a third machine learning model. In some examples, a z-score for the stated income with respect to the predicted income, a difference between the stated income 306 and the predicted income 324, or other suitable inputs can also be ingested into the third machine learning model. The third machine learning model can be an income misrepresentation model 316 trained and configured to output an income risk score 320 based on the inputs. In particular, the third machine learning model may be an SKlearn Logistic Regression model or an XGBoost classifier.

At block 418, the process 400 can involve generating, with the third machine learning model, an income risk score 320 indicating a likelihood that the stated income is overstated by at least a threshold amount relative to the true income of the borrower user. In the example, the income score can be 250, which can indicate a relatively low likelihood that the stated income is overstated by the threshold amount, which threshold amount may be 15%.

At block 420, the process 400 can involve the fraud detection system 200 transmitting a notification to a lender user device 316. The notification can include at least the predicted income 324, the absolute error estimate 322, and the income risk score 320. In some examples, the fraud detection system 200 may enable, via a user interface of the lender user device 116, a lender user to set a threshold for the income risk score 320. As a result, the fraud detection system 200 may transmit the notification when the income risk score 320 exceeds the threshold. Additionally, or alternatively the notification can correspond to a report, such as report 700 depicted in FIG. 7.

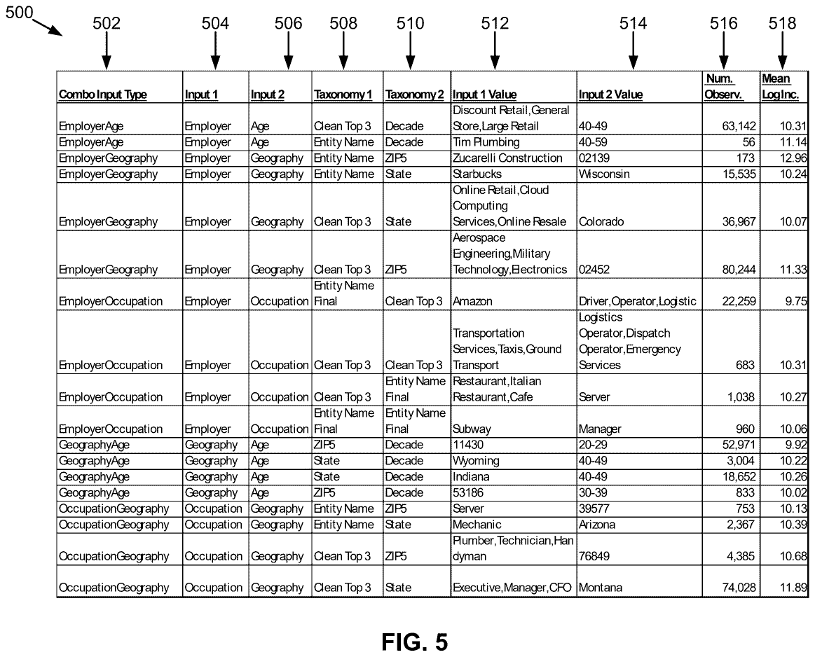

FIG. 5 illustrates a lookup table 500 for feature extraction according to an embodiment of the present disclosure. Each row in the lookup table 500 can correspond to a table feature 310. The lookup table 500 can include a first column 502 in which various examples of subsets of borrower attributes are shown. As illustrated, the subsets of borrower attributes can include “employer age”, “employer geography”, “employer occupation”, “geography age”, “occupation age”, and “occupation geography”. In other examples, there may be a different number of subsets of borrower attributes, or each subset may include a different number of borrower attributes. The lookup table 500 can further include a second column 504 indicating the first input (e.g., a first borrower attribute) included in a particular table feature 310. Similarly, a third column 506 of the lookup table can indicate a second input (e.g., a second borrower attribute) included in a particular table feature 310.

As shown in a fourth column 508 and a fifth column 510, various taxonomy levels can be associated with each subset of borrower attributes, and specifically, the fourth column 508 can indicate a taxonomy level for the second column 504, input 1, and the fifth column 510 can indicate a taxonomy level for the third column 506, input 2. For example, the inputs to a table feature 310 corresponding to the borrower attributes of employer and age may each have two taxonomy levels. The taxonomy levels used for a particular input within a feature may be fixed at a certain taxonomy level, or may be dynamic. For employer, a first taxonomy level can be referred to as “entity name final”, which may be a modified version of a raw entity (e.g., employer) name provided in an application. More specifically, the entity name final can be a most specific taxonomy value corresponding to the employer, identifying the specific employer by name. Alternatively, a taxonomy level for a particular input of a table feature may be dynamically determined, in which case the level of the taxonomy can be adjusted until at least a desired number of data points are seen at that level of the taxonomy. For example, in a circumstance in which a certain level of the taxonomy does not have at least a threshold number of data points, such as, for example, at least 50 data points, then the taxonomy level can be shifted to a next, more generic level until a level of the taxonomy is identified that has at least the threshold level of data points. More specifically, in one embodiment, a small coffee shop is identified as the employer, which small coffee shop is associated with less than 50 data points. Moving up a taxonomy level can correspond to shifting from the taxonomy level corresponding to the particular small coffee shop to a taxonomy level corresponding to all employers that are coffee shops. In this example, the taxonomy level for all coffee shops has more than 50 data points, and this taxonomy level can thus be selected and data from this taxonomy level can be used.

In some embodiments in which the level of the taxonomy is adjusted for one or more borrower attributes, the taxonomy level can be adjusted based on information identifying the next level for that borrower attribute. This information identifying the next level for that borrower attribute can be stored in, for example, a relational database, a lookup table, and/or the like. In one embodiment, for example, a lookup table can contain information linking employers to their industry. Thus, the name of a small coffee shop could be linked to the industry of coffee shops, restaurants, food service, and/or the like. In such an embodiment, the taxonomy level for a borrower attribute can be adjusted by querying the lookup table for information, such as a broader classification, relating to the attribute, receiving the information, and adjusting the taxonomy level based on the received information.

A second taxonomy level for employer can be referred to as “clean top 3,” which can correspond to the three most relevant taxonomy values. For example, for “Starbucks” the clean top 3 may include “Café”, “Coffee Shop”, and “Restaurant.” Similarly, for geography a first taxonomy level can be a zip code from the application and a second taxonomy level can be the state with the zip code. Data associated with taxonomy values corresponding to the indicated taxonomy level for each borrower attribute can be used to calculate feature values. Different combinations of taxonomy levels and taxonomy values for each table feature 310 can enable a range of relevant information to be provided to machine learning models to facilitate accurate predictions by the machine learning models.

A sixth column 512 contains a first input value (“input 1 value”) and a seventh column 514 contains a second input value (“input 2 value”). The sixth column 512 contains the input values corresponding to the input 1 in the second column 504 and taxonomy 1 in the fourth column 508. For example, the second row of the sixth column 512 contains the three most relevant taxonomy values for the employer, and the third row of the sixth column 512 contains the entity name of the employer. The seventh column 514 contains the input values corresponding to input 2 in the third column 506 and taxonomy 2 in the fifth column 510. For example, the second row of the seventh column 514 specifies a decade from 40-49, and the fourth row of the seventh column 514 specifies a five-digit zip code.

An eighth column 516 contains a number observed, specifically identifying a number of people corresponding to the categories of input 1 value and input 2 value, and a ninth column 518 contains a value identifying a mean natural log of income for corresponding to the information in the row. Specifically, the eighth column 516 indicates that there 61,142 people having an age between 40-49 years and who are employed in one or more of discount retail, general store, and large retail. The ninth column 518 indicates the mean natural log of income for the 63,142 people identified in the eight column 516. So, for example, the mean natural log of income for the 63,142 people identified in the eighth column 513 is 10.31 natural log dollars (corresponding to $30,031.44).

FIG. 6 illustrates another example of a lookup table 600 for feature extraction according to an embodiment of the present disclosure. Each row in the lookup table 600 can correspond to a table feature 310. The lookup table 600 can include a first column 602 for a subset of borrower attributes (e.g., employer and age). The lookup table 600 can further include a second column 604 indicating a taxonomy level. The taxonomy level can indicate the scope used to collect data associated with the borrower attributes. For example, the taxonomy level for the employer (e.g., Smith's Prime Custom Meats) can be three. Thus, the most closely related taxonomy values (e.g., supermarkets, groceries, and stores), which can be included in a third column 606 of the lookup table, can be used to collect data to determine feature values. For example, the taxonomy values can be used as keywords for querying a database with verified income data and historical application data. Additionally, a fourth column 608 of the lookup table 600 can include identifiers of statistics (e.g., a number of verified incomes, a percent of stated incomes which were overstated by at least 15% relative to a corresponding verified income, a mean of the verified incomes, etc.) calculated for each table feature 310. A fifth column 610 can show the feature values calculated for each statistic using the verified income data and historical application data, each of the feature values corresponding to the identifier in the fourth column 608.

FIG. 7 illustrates a sample output 700 according to an embodiment of the present disclosure. The sample output 700 can be a report for indicating an income risk score, predicted income, and predicted income range. The report may comprise application data, including borrower information (e.g., name, location, address, employer, and occupation). The report may further include application ID, loan amount, loan term, car make, car model, dealer ID, and the like (not shown).

Additionally, the report can include an income risk score (illustrated as score “800”), which may be determined as described above. The report may further include a risk level (illustrated as “high”). The risk level may be determined by comparing the score to one or more thresholds. For example, if the score is above a threshold (e.g., 600), a risk level of “high” may be determined. If the score is below a threshold (e.g., 300), a risk level of “low” may be determined. Each threshold may be associated with a different level of risk (e.g., low, moderate, and high). When there are multiples thresholds, a risk level may be defined as being between two thresholds. For example, a risk level of moderate can be associated with a score between 300 and 600.

The report can further include a stated income from an application submitted by the borrower. The report can also include a predicted income and an error for the predicted income. The stated income, predicted income, and error can provide supporting evidence for the income score. For example, the stated income being greater than the predicted income by more than 15% supports the output of a high risk level.

FIG. 8 illustrates another distributed computing system 800 for fraud detection according to an embodiment of the present disclosure. The fraud detection computer system 120 may receive information regarding a loan application using one or more interfaces. For example, the fraud detection computer system 120 may include a browser interface 802, a batch interface 804, and/or a loan origination system (LOS) 806. The browser interface 802 and the loan origination system 806 may be used to submit a loan application to the fraud detection computer system 120. The batch interface 804 may be used to submit multiple loan applications to the fraud detection computer system.

In some examples, browser interface 802 may correspond with a website provided for interfacing with a fraud detection computer system 120. The browser interface 802 may allow for a user (e.g., lender, borrower) to input (e.g., type, drag-and-drop, or provide a file such as XLS, TXT, or CSV) information to the browser interface 802. A borrower may submit their information to a lender. In other examples, the borrower may submit the information to one or more lenders directly. The information may be submitted in a secure manner, such as using HTTPS or SSL. The information may also be encrypted (e.g., PGP encryption).

In some examples, batch interface 804 may allow a user to upload a file (e.g., XLS, TXT, or CSV) to the fraud detection computer system. The file may include information associated with one or more loan applications. In some examples, the batch interface 804 may utilize SFTP to send and receive communications. Scheduled batch interface 804 may also encrypt the file (e.g., PGP encryption).

In some examples, loan origination system 806 may be a service (e.g., a web service) that provides a direct connection with the fraud detection computer system 120 (e.g., synchronous). The loan origination system 806 may operate on a borrower user device, a dealer user device, or a lender user device. The loan origination system 806 may generate an application object for information associated with a loan application, the application object directly used by the fraud detection computer system 120. The loan origination system 806 may then insert information into the application object. The loan origination system 806 may be a service that utilizes HTTP or SSL.

The fraud detection computer system 120 may further include a group firewall 808. The group firewall 808 may include one or more security groups (e.g., security group with whitelist IP list 810 and LOS security group 812). In some examples, the group firewall 208 may be configured to determine whether to allow electronic communications that originate from outside of group firewall 808 to be delivered to a computer system or device inside group firewall 808.

Security group with whitelist IP list 810 may include one or more Internet Protocol (IP) addresses that may be allowed to utilize processes described herein. For example, when a device executing a browser interface attempts to send borrower information, the IP address of the user device may be checked against whitelist IP list 810 to ensure that the user device has permission to utilize services described herein. In one illustrative example, a communication between browser interface and whitelist IP list 810 may be in the form of HTTPS. A similar process may occur when scheduled batch interface sends borrower user information or application data. In one example, an electronic communication between scheduled batch interface 804 and whitelist IP list 810 may be in the form of SFTP or PGP. Comparatively, the LOS security group 812 may manage security regarding the loan origination system 806 in a similar method as the security group with whitelist IP list 810.

Within the group firewall 808, the fraud detection computer system may include a virtual private cloud 820. The virtual private cloud 820 may host one or more services described herein. For example, the virtual private cloud 820 may host a file processing service. The file processing service may decrypt information received from the browser interface 802 or the batch interface 804, generate an application object (as described above), decrypt information that was previously encrypted for electronic communications, and/or insert the decrypted information into the application object.

Within the group firewall 808, the fraud detection computer system may include a private subnet 822. The private subnet 822 may include ASYNC service, SYNC service, scoring service, master risk database, or any combination thereof. ASYNC service and SYNC service may facilitate requests to be sent to scoring service 830. In particular, ASYNC service may be used for asynchronous communications, as described with the browser interface 802 and the batch interface 804. SYNC service may be used for synchronous communications, as described with the loan origination system 806.

The scoring service 830 may receive additional information from a master risk database. The additional information may include information not associated with the application. For example, the additional information may be associated with other applications to be used for comparison. In one illustrative example, master risk database may be a location where verified incomes related to various occupations, employers, or previous load applications is stored so it may be analyzed and used by scoring service 830. The scoring service 830 may calculate an income risk score indicative of a likelihood that a stated income in an application is overstated by at least a threshold amount related to a true income.

In the forgoing description, for the purposes of explanation, specific details are set forth in order to provide a thorough understanding of examples of the disclosure. However, it should be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may have been shown without necessary detail in order to avoid obscuring the examples. The figures and description are not intended to be restrictive.

The description provides examples only, and is not intended to limit the scope, applicability, or configuration of the disclosure. Rather, the description of the examples provides those skilled in the art with an enabling description for implementing an example. It should be understood that various changes may be made in the function and arrangement of elements without departing from the spirit and scope of the disclosure as set forth in the appended claims.

Also, it is noted that individual examples may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable storage medium” or “computer-readable storage medium” includes, but is not limited to, portable or non-portable storage devices, optical storage devices, and various other mediums capable of storing, including, or carrying instruction(s) and/or data. A machine-readable storage medium or computer-readable storage medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some embodiments, the systems may be configured as a distributed system where one or more components of the system are distributed across one or more networks such as in a cloud computing system.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The terms and expressions that have been employed in this disclosure are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although certain concepts and techniques have been specifically disclosed, modification and variation of these concepts and techniques may be resorted to by those skilled in the art, and that such modifications and variations are considered to be within the scope of the systems and methods as defined by this disclosure.

Although specific embodiments have been described, various modifications, alterations, alternative constructions, and equivalents are possible. Embodiments are not restricted to operation within certain specific data processing environments but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product including computer program code or instructions executable by one or more processors for performing any or all of the steps, operations, or processes described in this disclosure, where the computer program may be stored on a non-transitory computer readable medium. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method for computing an income risk score, an income prediction, and an income range prediction, the method comprising:
receiving an application associated with a borrower user, the application comprising application data and a stated income;
identifying borrower attributes based on the application data;
accessing a lookup table that relates subsets of the borrower attributes with a plurality of feature values, wherein the plurality of feature values are computed using verified income data corresponding to the borrower attributes;
obtaining a plurality of table features from the lookup table, wherein each table feature of the plurality of table features comprises a subset of the borrower attributes and a feature value;
ingesting the plurality of table features into a first machine learning model;
generating, with the first machine learning model and based on the plurality of table features, a predicted income for the application;
generating, by a second machine learning model in which the predicted income and the plurality of table features are ingested, an income range estimate indicating a lower bound and upper bound that comprise a range that has a particular likelihood of containing a true income of the borrower user;
ingesting the predicted income, the income range estimate, and the plurality of table features into a third machine learning model; and
generating, with the third machine learning model and based on the predicted income, the income range estimate, and the plurality of table features, an income risk score indicating a likelihood that the stated income is overstated by at least a threshold amount relative to the true income of the borrower user.

2. The method of claim 1, further comprising:
identifying, for each of the borrower attributes, at least one taxonomy value;
wherein the lookup table relates the subsets of the borrower attributes with the plurality of feature values using verified income data associated with the at least one taxonomy value for each of the borrower attributes; and
wherein each table feature of the plurality of table features comprises the subset of the borrower attributes, the feature value, and at least one taxonomy value.

3. The method of claim 2, wherein identifying the at least one taxonomy value for the employer and for the occupation comprises inputting the employer and the occupation into a generative artificial intelligence model configured to output an employer category, an employer subcategory, an occupation category, and an occupation subcategory.

4. The method of claim 3, wherein inputting the employer and the occupation into the generative artificial intelligence model configured to output an employer category is before generation of a prediction with one of the machine learning models.

5. The method of claim 1, further comprising, prior to ingesting the plurality of table features into the third machine learning models:
retrieving, for each table feature of the plurality of table features, a feature value, a prior value, and a number of data records used to calculate the feature value; and
performing, for each table feature of the plurality of table features, a statistical smoothing update in which the feature value is updated based on a computation of the feature value and the prior value and based on the number of data records.

6. The method of claim 5, wherein the smoothing update comprises a Bayesian update.

7. The method of claim 1, further comprising, subsequent to generating the income score:
adjusting the predicted income based on the income score and based on a difference between the predicted income and the stated income; and
providing the adjusted predicted income, the income range estimate, and the income score to a lender user device.

8. The method of claim 1, further comprising, subsequent to generating the income score:
adjusting the income range estimate based on the income risk score; and
providing the predicted income, the adjusted income range estimate, and the income risk score to a lender user device.

9. The method of claim 1, wherein income score indicates the likelihood that the stated income is overstated by at least 15% relative to the true income of the borrower user.

10. The method of claim 1, wherein the borrower attributes comprise an employer, an occupation, an age, and a geographic indicator.

11. The method of claim 1, wherein the income range estimate comprises a predicted absolute error of the income prediction.

12. The method of claim 1, wherein the income range estimate is generated based on a quantile regression.

13. The method of claim 1, wherein the income range estimate has a 50% likelihood of containing an actual income of the borrower.

14. A non-transitory computer-readable storage medium storing a plurality of instructions executable by one or more processors, the plurality of instructions when executed by the one or more processors cause the one or more processors to perform operations comprising:
receiving an application associated with a borrower user, the application comprising application data and a stated income;
identifying borrower attributes based on the application data;
accessing a lookup table that relates subsets of the borrower attributes with a plurality of feature values, wherein the plurality of feature values are computed using verified income data corresponding to the borrower attributes;
obtaining a plurality of table features from the lookup table, wherein each table feature of the plurality of table features comprises a subset of the borrower attributes and a feature value;
ingesting the plurality of table features into a first machine learning model;
generating, with the first machine learning model and based on the plurality of table features, a predicted income for the application;
generating, by a second machine learning model in which the predicted income and the plurality of table features are ingested, an income range estimate indicating a lower bound and upper bound that that comprise a range that has a particular likelihood of containing a true income of the borrower user;
ingesting the predicted income, the income range estimate, and the plurality of table features into a third machine learning model; and
generating, with the third machine learning model and based on the predicted income, the income range estimate, and the plurality of table features, an income risk score indicating a likelihood that the stated income is overstated by at least a threshold amount relative to the true income of the borrower user.

15. The non-transitory computer-readable storage medium of claim 14, wherein the operations further comprise:
identifying, for each of the borrower attributes, at least one taxonomy value;
wherein the lookup table relates the subsets of the borrower attributes with the plurality of feature values using verified income data associated with the at least one taxonomy value for each of the borrower attributes; and
wherein each table feature of the plurality of table features comprises the subset of the borrower attributes, the feature value, and at least one taxonomy value.

16. The non-transitory computer-readable storage medium of claim 15, wherein the operation of identifying the at least one taxonomy value for the employer and for the occupation comprises inputting the employer and the occupation into a generative artificial intelligence model configured to output an employer category, an employer subcategory, an occupation category, and an occupation subcategory.

17. The non-transitory computer-readable storage medium of claim 16, wherein inputting the employer and the occupation into the generative artificial intelligence model configured to output an employer category is before generation of a prediction with one of the machine learning models.

18. The non-transitory computer-readable storage medium of claim 14, wherein the operations further comprise, prior to ingesting the plurality of table features into the third machine learning model:
retrieving, for each table feature of the plurality of table features, a feature value, a prior value, and a number of data records used to calculate the feature value; and
performing, for each table feature of the plurality of table features, a statistical smoothing update in which the feature value is updated based on a computation of the feature value and the prior value and based on the number of data records.

19. The non-transitory computer-readable storage medium of claim 18, wherein the smoothing update comprises a Bayesian update.

20. The non-transitory computer-readable storage medium of claim 14, wherein the operation further comprise, subsequent to generating the income score:
adjusting the predicted income based on the income score and based on a difference between the predicted income and the stated income; and
providing the adjusted predicted income, the income range estimate, and the income score to a lender user device.

21. The non-transitory computer-readable storage medium of claim 14, wherein the operations further comprise, subsequent to generating the income score:
adjusting the income range estimate based on the income risk score; and
providing the predicted income, the adjusted income range estimate, and the income risk score to a lender user device.

22. The non-transitory computer-readable storage medium of claim 14, wherein income score indicates the likelihood that the stated income is overstated by at least 15% relative to the true income of the borrower user.

23. The non-transitory computer-readable storage medium of claim 14, wherein the borrower attributes comprise an employer, an occupation, an age, and a geographic indicator.

24. The non-transitory computer-readable storage medium of claim 14, wherein the income range estimate comprises a predicted absolute error of the income prediction.

25. The non-transitory computer-readable storage medium of claim 14, wherein the income range estimate is generated based on a quantile regression.

26. The non-transitory computer-readable storage medium of claim 14, wherein the income range estimate has a 50% likelihood of containing an actual income of the borrower.

27. A system comprising:
one or more processors; and
a non-transitory computer-readable medium including instructions that, when executed by the one or more processors, cause the one or more processors to perform operations comprising:
receiving an application associated with a borrower user, the application comprising application data and a stated income;
identifying borrower attributes based on the application data;
accessing a lookup table that relates subsets of the borrower attributes with a plurality of feature values, wherein the plurality of feature values are computed using verified income data corresponding to the borrower attributes;
obtaining a plurality of table features from the lookup table, wherein each table feature of the plurality of table features comprises a subset of the borrower attributes and a feature value;
ingesting the plurality of table features into a first machine learning model;
generating, with the first machine learning model and based on the plurality of table features, a predicted income for the application;
generating, by a second machine learning model in which the predicted income and the plurality of table features are ingested, an income range estimate indicating a lower bound and upper bound that that comprise a range that has a particular likelihood of containing a true income of the borrower user;
ingesting the predicted income, the income range estimate, and the plurality of table features into a third machine learning model; and
generating, with the third machine learning model and based on the predicted income, the income range estimate, and the plurality of table features, an income risk score indicating a likelihood that the stated income is overstated by at least a threshold amount relative to the true income of the borrower user.

28. The system of claim 27, wherein the operations further comprise:
identifying, for each of the borrower attributes, at least one taxonomy value;
wherein the lookup table relates the subsets of the borrower attributes with the plurality of feature values using verified income data associated with the at least one taxonomy value for each of the borrower attributes; and
wherein each table feature of the plurality of table features comprises the subset of the borrower attributes, the feature value, and at least one taxonomy value.

29. The system of claim 28, wherein the operation of identifying the at least one taxonomy value for the employer and for the occupation comprises inputting the employer and the occupation into a generative artificial intelligence model configured to output an employer category, an employer subcategory, an occupation category, and an occupation subcategory.

30. The system of claim 29, wherein inputting the employer and the occupation into the generative artificial intelligence model configured to output an employer category is before generation of a prediction with one of the machine learning models.

31. The system of claim 27, wherein the operations further comprise, prior to ingesting the plurality of table features into the third machine learning model:
retrieving, for each table feature of the plurality of table features, a feature value, a prior value, and a number of data records used to calculate the feature value; and
performing, for each table feature of the plurality of table features, a statistical smoothing update in which the feature value is updated based on a computation of the feature value and the prior value and based on the number of data records.

32. The system of claim 31, wherein the smoothing update comprises a Bayesian update.

33. The system of claim 27, wherein the operations further comprise, subsequent to generating the income score:
adjusting the predicted income based on the income score and based on a difference between the predicted income and the stated income; and
providing the adjusted predicted income, the income range estimate, and the income score to a lender user device.

34. The system of claim 27, wherein the operations further comprise, subsequent to generating the income score:
adjusting the income range estimate based on the income risk score; and
providing the predicted income, the adjusted income range estimate, and the income risk score to a lender user device.

35. The system of claim 27, wherein the borrower attributes comprise an employer, an occupation, an age, and a geographic indicator.

36. The system of claim 27, wherein the income range estimate comprises a predicted absolute error of the income prediction.

37. The system of claim 27, wherein the income range estimate is generated based on a quantile regression.

38. The system of claim 27, wherein the income range estimate has a 50% likelihood of containing an actual income of the borrower.
